(19) United States
(12) Patent Application Publication
(10) Pub. No.: US 2002/0094093 A1
(43) Pub. Date: Jul. 18, 2002

(54) Sound Collector

(75) Inventors: Alexander Paritsky, Modiin (IL); Alexander Kots, Ashdod (IL); Okihiro Kobayashi, Tokyo (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: PHONE-OR LTD.

(21) Appl. No.: 09/884,503

(22) Filed: Jun. 14, 2001

(30) Foreign Application Priority Data
Oct. 15, 1999 (JP) 11-294216

(51) Int. Cl. H04R 3/00; H04B 15/00

(52) U.S. Cl. 381/92; 381/93; 381/122

(57) ABSTRACT

A sound collector comprises switch means (55) for selecting one of the microphones (50a, 50b) directed to sound collection objects (60, 65) the angle between which is θ. The microphone is an optical microphone comprising a diaphragm (2), a light source (3) for irradiating the diaphragm (2), a photodetector (5) outputting a vibration signal of the diaphragm (2), a light source driving circuit (13), and a negative feedback circuit (100) for supplying the output from the photodetector (5) to the light source driving circuit (13). The difference of the sensitivity between the sound collecting objects is eliminated by selecting one of the microphones through the switch means (55) and thereby changing the amount of negative feedback.

### CROSS-REFERENCES TO RELATED APPLICATIONS

International Publication No.: WO 01/28283

International Application No.: PCT/JP00/07167

International Application Date: Oct. 16, 2000 (10.16.2000)

Priority No.: Japanese Patent Application No. 11-294216

Priority Date: Oct. 15, 1999 (10.15.1999) JP

### BACKGROUND OF THE INVENTION

1. Technical Field

This invention relates to a sound collector. Especially, it relates to a sound collector provided with two microphones in which its sensitivity is almost equal even if a distance from the sound collection object is different.

2. Description of the Related Art

A conventional sound collector called an arrayed microphone provided with multiple microphones generally adopted a configuration shown in FIG. 9 to get the effect on noise cancellation to decrease the surrounding noise. Multiple microphones 20₁, 20₂, 20₃ . . . 20_{N}, and so on are arranged in the same interval, and they are fixed on the support frame 40 to make an arrayed microphone. As the signal strength and phase of the voice that enters in the pairs of microphones from the far range is almost equal to each other, an aural signal by the voice from the distance can be canceled by inverting the phase of the aural signal of one microphone and laying it to the signal of the other.

Further, in the case from the short distance, because voice is being inputted in different phase and in different signal strength by each microphone unit, the aural signal which has directivity can be taken out by detecting that phase and signal strength. Therefore, as for the voice from the short distance, a detection of the aural signal that has directivity can be done. As for the aural signal from the far range, the aural signal that canceled noise and so on can be taken out.

However, with the arrayed microphone shown in FIG. 9, the sensitivity of each microphone is made low, and only the voice from the speaker of the short distance is caught with directivity. Therefore, there was a problem that sound collection became difficult when a distance to the speaker from the microphone became long. Further, the use of more than one microphone element is essential for noise cancellation and for directivity. Furthermore, because there was characteristic dispersion between the microphone elements, there was a problem that it was very difficult to get effect on noise cancellation by taking correlation between the elements, and to get directivity. To solve these problems, this invention provides a sound collector that collects sound in the equal sensitivity even when a distance between the speaker and the microphone is different without using many microphone elements.

### BRIEF SUMMARY OF THE INVENTION

The sound collector of this invention comprises a first microphone oriented for a first sound collection object in a first distance in a first direction; a second microphone oriented for a second sound collection object in a second distance in a second direction to make a predetermined angle in the first direction; and switching means that selectively changes between the first microphone and the second microphone; wherein the above microphone is an optical microphone that comprises a diaphragm to vibrate by the sound pressure; an illuminant to irradiate an optical beam to the above diaphragm; a photodetector which receives a reflection light of the light beam irradiated in the diaphragm and which outputs a signal which copes with the oscillation of the diaphragm; an illuminant drive circuit to drive the illuminant to supply predetermined electric current; and a negative feedback circuit that supplies the signal outputted by the optical detector to the illuminant drive circuit as a negative feedback signal; and wherein the amount of negative feedback of the negative feedback circuit is changed with switching of the microphone by the switching means.

Moreover, in the sound collector of this invention, the gain of the negative feedback can be set up respectively so that the voice output signal level may be almost equal between the first microphone and the second microphone. Furthermore, in the sound collector of this invention, the gain of the negative feedback can be set up corresponding to the first distance and the second distance respectively.

### BRIEF DESCRIPTION OF THE DRAWINGS

FIG. 1 shows a point part composition of the sound collector of this invention.

FIG. 2 shows a gradation of the directivity pattern of optical microphone element to use for this invention.

FIG. 3 shows a structure of optical microphone element to use for this invention.

FIG. 4 shows a structure of another optical microphone element that it is used for this invention.

FIG. 5 shows an outline composition of an optical microphone device to use for this invention.

FIG. 6 shows a gradation of the directivity response pattern of the optical microphone element of FIG. 4.

FIG. 7 shows directional characteristics pattern of the optical microphone element used for this invention.

FIG. 8 shows a structure of the microphone unit used for this invention.

FIG. 9 shows a configuration of the conventional arrayed microphone device.

In these figures, 2 is diaphragm, 3 is light source, 5 is photodetector, 7 is sound wave, 13 is light source drive circuit, 50 is optical microphone element, 55 is changeover switch, 60 is driver's seat, 65 is assistant seat, 100 is negative feedback circuit and 300 is microphone unit.

### DESCRIPTION OF THE SPECIFIC EMBODIMENTS

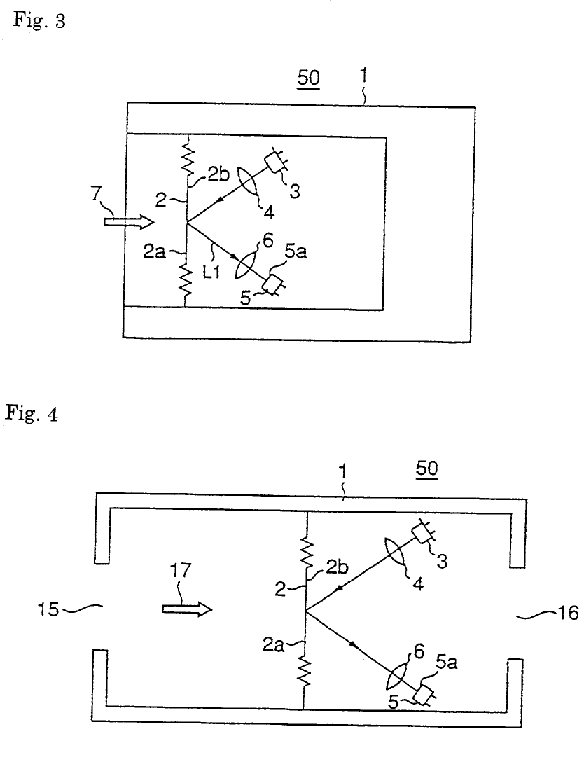

With the sound collector of this invention, two microphone elements installed in the same location are oriented to a sound collection object by the predetermined included angle and these microphone elements are composed to toggle selectively. Optical microphone elements are adopted as microphone elements. First, the fundamental principle of the optical microphone and its structure are explained below. FIG. 3 shows a structure of the head part of an optical microphone element 50. A diaphragm 2 which oscillates by a sound wave is provided in the microphone head 1, and a surface 2a at the side which a sound wave hits is exposed to the outside. Therefore, a sound wave 7 reaches this surface 2a, and oscillates this diaphragm 2. Inside the head 1 located in the opposite surface 2b of the diaphragm 2 against the surface 2a, a light source 3 such as LED irradiating a light beam in the surface 2b of the diaphragm 2, a lens 4 to make a light beam from this light source 3 predetermined beam shape, a photodetector 5 which receives the reflection light reflected in the surface 2b, and a lens 6 to zoom the displacement of the optical path of the reflection light caused by the oscillation of the diaphragm 2, are set up. When a sound wave 7 hits the surface 2a of the diaphragm 2 and a diaphragm 2 oscillates, the receiving position of the reflection light that enters to the receiving surface 5a of the photodetector 5 changes.

If a photodetector 5 is composed as a position sensor, an electric signal which met the oscillation of the diaphragm 2 from the irradiation location of the reflection light is taken out. This is the basic structure of the optical microphone. However, effect on a noise decrease can't be expected with the optical microphone that shows it in the FIG. 3 very much. This is because a diaphragm 2 also oscillates by the noise which reaches a diaphragm 2 and this is piled as a noise signal by oscillation by the usual sound wave 7.

As an optical microphone which reduces the influence of this noise and attempts effect on a noise decrease, a structure shown in FIG. 4 is known. In the structure shown in FIG. 4, the diaphragm 2, which oscillates by the sound wave 7, is provided in almost the center of the head 1. Then, on both sides of the head 1, a 1st opening 15 and a 2nd opening 16 are set up to become symmetrical location to each other. By composing it like this, a sound wave gets into the head 1 from the both openings to oscillate the diaphragm 2.

In the optical microphone element 50 shown in FIG. 4, when the phase and the amplitude of the sound wave from the 1st opening 15 and those of the sound wave from the 2nd opening 16 are equal, these two sound waves interfere with each other in both sides 2a and 2b of the diaphragm 2, and never oscillate the diaphragm 2. When two microphones that have equal sensitivities are arranged close and they receive the sound wave which occurred in the far range, the two microphone elements detect the sound wave equally.

Generally, a sound wave occurs from the mouth of the person in the short distance to the microphone element. In other words, most voice occurs at the short distance from this microphone element. The voice of the person of this short distance has globular field characteristics so that it may be shown by a circular curve. As for the sound wave by the noise sound which occurs in the far range has the characteristics of the plane field. Though the sound intensity of the globular wave is about the same along that spherical surface or the envelope and changes along the radius of that glob, sound intensity of the plane wave almost becomes the same in all the plane points.

As the optical microphone element shown in FIG. 4 can be thought to associate two microphone element, when this was put on the far range field, the sound waves which have almost the same amplitude and phase characteristics from the 1st opening 15 and the 2nd opening 16 comes in the diaphragm 2 to interfere with each other, and those influences are decreased. On the other hand, as a sound wave from the short distance field enters from the 1st opening 15 or the 2nd opening 16 non-uniformly, a sound wave from the short distance field oscillates a diaphragm 2, and it is taken out as a signal by the photodetector 5. The structure of FIG. 4 can provide the optical microphone element which reduces the influence of the noise more.

FIG. 7 shows directivity response patterns of the optical microphone element shown in FIG. 3 and FIG. 4. FIG. 7A shows a directivity response pattern of the optical microphone element 50 shown in FIG. 3. This optical microphone element 50 has an almost circular-shaped directivity response pattern, and has optimum sensitivity in the direction which is vertical to the diaphragm 2 toward the opening (the left side direction of the figure). FIG. 7B shows a directivity response pattern of the optical microphone element 50 shown in FIG. 4. This optical microphone element 50 has almost “8” shaped directivity response pattern, and has optimum sensitivity in both directions of the openings 15 and 16.

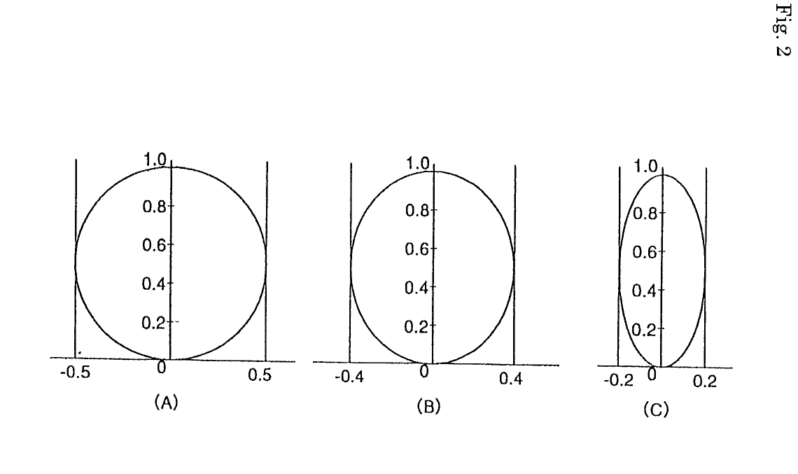

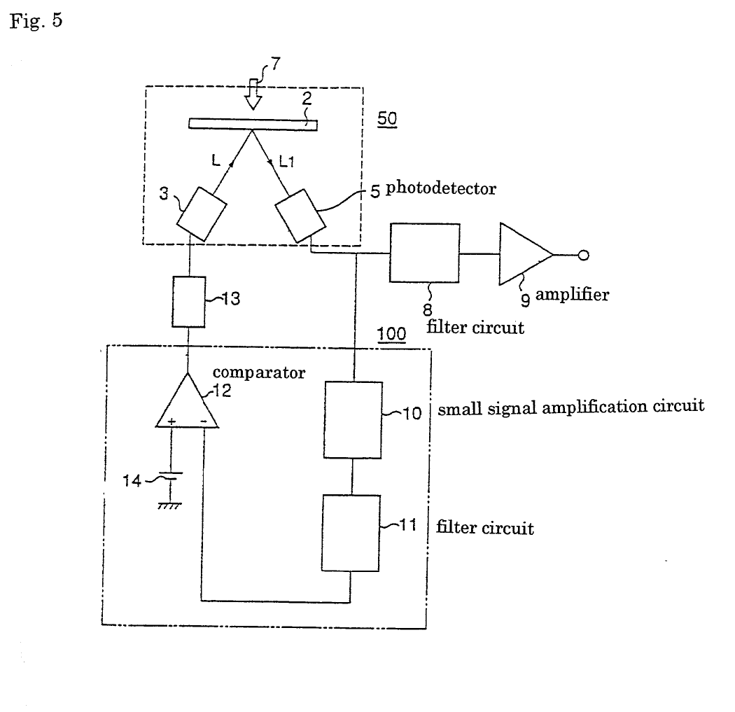

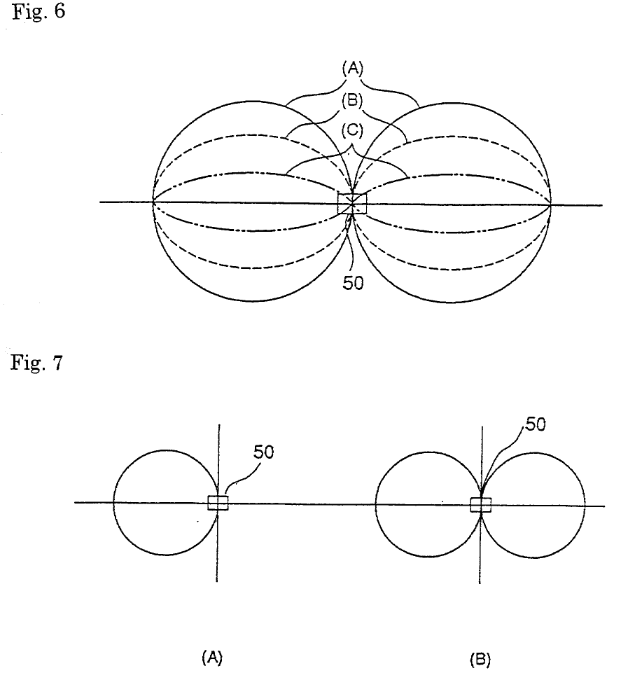

The directivity response pattern of the optical microphone element 50 shown in FIG. 3 and FIG. 4 can be stretched along the axis having optimum sensitivity as shown in FIG. 2 or FIG. 6. Also, the directivity response pattern can be narrowed along the direction which is vertical to the axis. To make the pattern of the directivity change like this, a part of the detection output from the photodetector 5 should be negatively feedbacked by using the negative feedback circuit to the light source drive circuit that drives light source 3. FIG. 5 shows an outline configuration of an optical microphone device which used a feedback circuit 100 to make a beam pattern change such as FIG. 2 or FIG. 6.

Output from the photodetector 5 is taken out through the filter circuit 8, amplified by an amplifier 9, and it becomes microphone output. A filter circuit 8 is used to take out a requested signal component of the frequency range. Here, with the optical microphone device shown in FIG. 5, it is composed to supply a part of the output signal taken out from this photodetector 5 to the light source drive circuit 13 through the negative feedback (NFB) circuit 100 as a negative feedback signal. Light source drive circuit 13 drives this light source 3 by supplying predetermined electric current to the light source 3.

Negative feedback circuit 100 comprises a small signal amplification circuit 10, a filter circuit 11 which takes out a signal component of the requested frequency range from the output from the small signal amplification circuit 10, and a comparator 12. A norm power source 14 which provides reference voltage is connected to the non-inversion input terminal of the comparator 12. The signal taken out through the filter circuit 11 is supplied to the reverse input terminal of the comparator 12. When it is composed like this, a little output level is outputted as much as the output of the filter circuit 11 of the comparator 12 is big, and light source drive circuit 13 is actuated by this to reduce electric current supplied to the light source 3.

Only when an input signal level is less than a predetermined level, small signal amplification circuit 10 amplifies that signal, and a certain signal beyond the level is not amplified. Therefore, an output signal level doesn't change in the case the input signal level is beyond a predetermined level, and amplification degree (gain) becomes 0. When an input signal is less than a predetermined signal level, it amplifies so that amplification degree may grow big as much as a signal level is small. Furthermore, the rate of increase of the output signal toward the input signal rises as much as an input signal level is small. As an output from the photodetector 5 is in proportion to the received sound volume, the output of the small signal amplification circuit 10 is greatly amplified and outputted.

Because this output is being inputted to the reverse input terminal of the comparator 12 through the filter circuit 11, the output of the comparator 12 decreases conversely as much as small sound volume. As that result, the electric current supplied to the light source 3 is actuated so that small sound volume may make the optical output of the light source 3 decline. Id est, the sensitivity of the microphone declines as much as small sound volume. As a signal beyond the predetermined level isn't amplified, optical output isn't restricted by that signal level. Therefore the sensitivity of the microphone never declines.

When the sound which came from the axis direction which was vertical to the diaphragm and which has a volume that does not cause the sensitivity decline of the microphone is moved from the axis direction, sensitivity gradually declines along the original directivity response pattern curve. Then, when the sensitivity becomes less than a certain level, small signal amplification circuit 10 comes to have amplification degree, and the electric current control of the light source drive circuit 13 works, and the sensitivity of the microphone declines more. As this result, with the optical microphone device which has negative feedback circuit 100, the width of the directivity beam is more limited than the directivity response pattern of the sensitivity as shown in FIG. 2 and FIG. 6.

FIG. 2 and FIG. 6 show pattern gradations of directivity by changing the gain of negative feedback. In these figures, (A) shows the directivity response pattern when negative feedback isn't made, and almost becomes a circular directivity response pattern in this case. Next, directivity response patterns under negative feedback are shown in (B) and (C). The gain of negative feedback is small in the case of (B), and the gain of negative feedback is big in the case of (C). As shown in these figures, the gain of negative feedback is made to change by varying the amplification degree of the small signal amplification circuit 10. The directivity response pattern of the sensitivity can be stretched along the axis direction of the optimum sensitivity by this, or narrowed in the direction that is vertical to the axis. Thus, the directional characteristics of the sensitivity of the optical microphone can be changed.

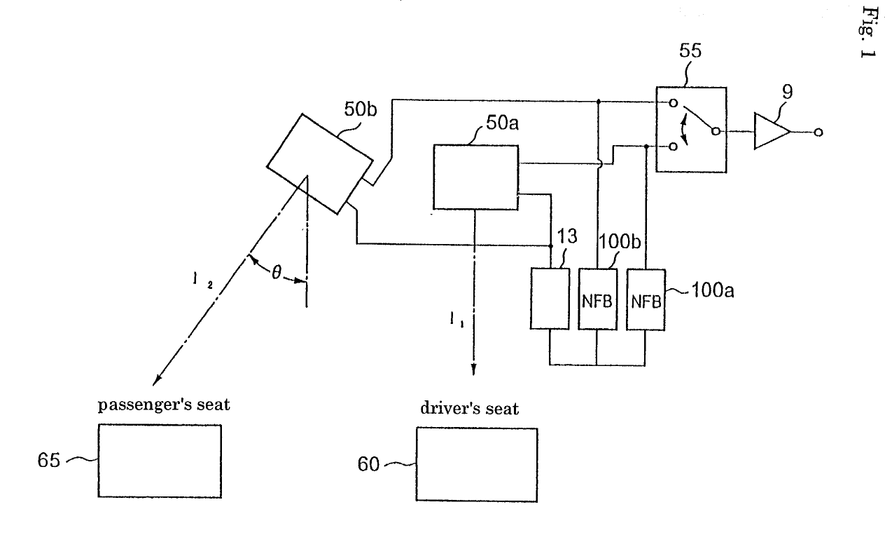

The sound collector of this invention changes the directional characteristics of a selected microphone by using the optical microphone that may change the beam pattern of directivity. FIG. 1 shows a point part configuration of the sound collector of an embodiment of this invention. The above-mentioned optical microphone is used in this invention. The sound collector of this invention is consisting as a hands free sound collector installed in a dashboard of a car. Two optical microphone elements 50a, 50b are provided in the direction to each of the driver's seat 60 and the passenger's seat 65 and have a predetermined included angle θ.

In this case, because the optical microphone elements 50a and 50b are in almost the same location, the distance 11 to the driver's seat 60 and the distance 12 to the passenger's seat from the optical microphone element are different and there is a predetermined included angle θ. Thus, the diaphragms 2 of the optical microphone elements 50a, 50b are installed to become parallel to the driver's seat 60 and the passenger's seat 65, respectively, to have an included angle θ. In this construction, the sensitivity directivity of each microphone element becomes the biggest on the driver's seat 60 or the passenger's seat 65.

Detection output from each microphone element is inputted in each of the contact points of the changeover switch 55. By toggling changeover switch 55, the sound detected by optical microphone element is taken out through the amplifier 9 as an output signal. A part of the output signal from the optical microphone element 50a negatively feedbacked to the light source drive circuit 13 through the negative feedback circuit 100a, and the detected signal from the optical microphone element 50b is negatively feedbacked to the light source drive circuit 13 through the negative feedback circuit 100b. The gain of negative feedback of the negative feedback circuit 100a, 100b is set up to be respectively different corresponding to the distance 11 or the distance 12.

The setting of the gain of negative feedback is possible by changing the amplification degree of the small signal amplification circuit 10 inside the negative feedback circuit. Like this, by changing the gain of negative feedback corresponding to the distance 11 and 12, the aural output signal level can be almost equal even the voice was from whichever side changed by the switching switch 55. In other words, when a distance 11 to the driver's seat 60 is shorter than a distance 12 to the passenger's seat 65, the gain of negative feedback of the negative feedback circuit 100a is made smaller than the gain of negative feedback of the negative feedback circuit 100b, and the beam width of the directivity response pattern is made wide. By doing this, a difference in the sound collection sensitivity by a distance to the microphone unit from the driver's seat and the passenger's seat being different can be dissolved.

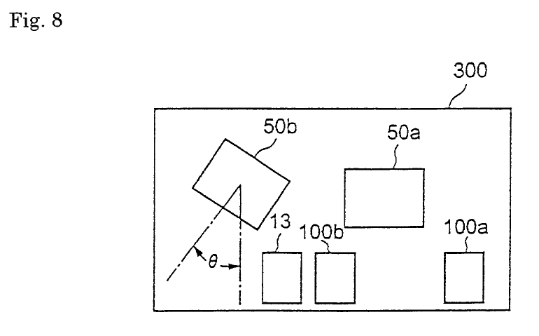

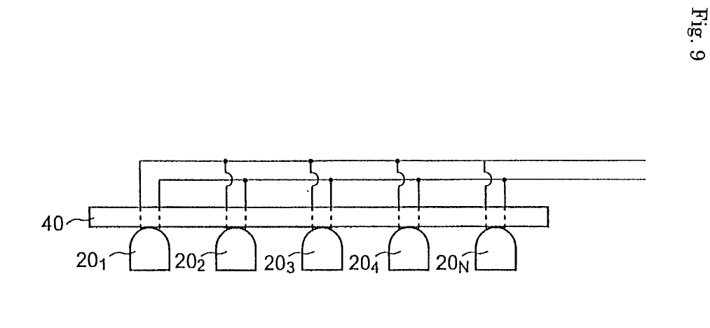

FIG. 8 shows a microphone unit 300. In this unit, the optical microphone elements 50a and 50b that were arranged to each other in the included angle θ, the power source drive circuit 13 to drive the optical microphone elements, and the negative feedback circuits 100a and 100b to establish a different gain of negative feedback for each optical microphone element are built in. In the embodiment shown in the FIG. 1, although changeover is done by the changeover switch 55 by the manual operation to collect voice from the driver's seat 60 and voice from the passenger's seat 65, the changeover may be achieved by toggling the contact point of the changeover switch 55 automatically by detecting the voice of the driver's seat 60 or the passenger's seat 65 automatically. Also, the configurations shown in FIG. 3 and FIG. 4 may be equally used for the configuration of the optical microphone elements 50a, 50b. However, as stated above, the configuration of FIG. 4 may prevent the influence of the noise better.

As explained above, in this invention, the sound collector collects sound by using the optical microphone toward the sound collection object in the different distance in two directions and by interlocking the changeover of the microphone, the gain of negative feedback of the optical microphone is changed. Therefore, a difference in sensitivity by the difference in the distance to the sound collection object can be dissolved.

What is claimed is:

1. A sound collector comprising:
a first microphone oriented for a first sound collection object in a first distance in a first direction;
a second microphone oriented for a second sound collection object in a second distance in a second direction to make a predetermined angle in the first direction; and
switching means that selectively changes between the first microphone and the second microphone;
wherein the above microphone is an optical microphone that comprises:
a diaphragm to vibrate by the sound pressure;
an illuminant to irradiate an optical beam to the above diaphragm;
a photodetector which receives a reflection light of the light beam irradiated in the diaphragm and which outputs a signal which copes with the oscillation of the diaphragm;
an illuminant drive circuit to drive the illuminant to supply predetermined electric current; and
a negative feedback circuit that supplies the signal outputted by the optical detector to the illuminant drive circuit as a negative feedback signal; and
wherein the amount of negative feedback of the negative feedback circuit is changed with switching of the microphone by the switching means.

2. The sound collector according to claim 1, wherein the gain of the negative feedback can be set up respectively so that the voice output signal level may be almost equal between the first microphone and the second microphone.

3. The sound collector according to claim 1, wherein the gain of the negative feedback can be set up corresponding to the first distance and the second distance respectively.
